(19) United States
(12) Patent Application Publication
(10) Pub. No.: US 2007/0046208 A1
(43) Pub. Date: Mar. 1, 2007

(54) Plasma display panel

(76) Inventors: Kyoung-Doo Kang, Suwon-si (KR); Won-Ju Yi, Suwon-si (KR); Ho-Young Ahn, Suwon-si (KR); Dong-Young Lee, Suwon-si (KR); Soo-Ho Park, Suwon-si (KR); Seok-Gyun Woo, Suwon-si (KR); Jae-Ik Kwon, Suwon-si (KR)

Correspondence Address: Robert E. Bushnell, Suite 300, 1522 K Street, N.W., Washington, DC, 20005, US

(21) Appl. No.: 11/511,272

(22) Filed: Aug. 29, 2006

(30) Foreign Application Priority Data
Aug. 30, 2005 (KR) 10-2005-0080024

(51) Int. Cl. H01J 17/49

(52) U.S. Cl. 313/582

(57) ABSTRACT

The present invention provides a plasma display panel (PDP) that prevents a frit or a sealing material from entering into a display region during a sealing process of the PDP. The plasma display panel includes a pair of substrates spaced apart from each other by a predetermined gap and facing each other, and a sheet interposed between the pair of substrates. First discharge electrodes and second discharge electrodes are disposed inside the sheet. The second discharge electrodes are spaced apart from the first discharge electrodes. The sheet includes a barrier rib part and a dielectric part. The barrier rib part has a plurality of holes that defines discharge cells together with the pair of substrates. A frit or sealing material is interposed between the dielectric part and each of the pair of the substrates. The frit seals a space formed between the pair of the substrates. A groove is formed on the surface of one substrate of the pair of the substrates. The groove is formed around edge of the substrate outside display region, so that the groove effectively prevent frit from spreading into the display region during manufacturing process of the PDP

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on 30 Aug. 2005 and there duly assigned Serial No. 10-2005-0080024.

### BACKGROUND OF THE INVENTION

1. Field of the Invention

The present invention relates to a plasma display panel (PDP) and, more particularly, to a PDP that is designed to prevent its display region from being contaminated by frit.

2. Description of the Related Art

Plasma display panels (PDPs), which have replaced conventional cathode ray tube (CRT) display devices, display images using visible rays generated by applying discharge voltage to discharge gas sealed between two substrates. A plurality of electrodes are formed on the substrates, and ultraviolet rays are first generated by applying voltage through the electrodes. The ultraviolet rays excite phosphor formed inside PDP, which as a result generates visible light.

Discharge cells of a PDP are formed between barrier ribs which are formed between two substrates. Discharge electrodes cross the discharge cells to apply voltage to the discharge cells. The two substrates are sealed with frit at a predetermined thickness around edges of the two substrates. Discharge gas is injected into the space between the substrates sealed with frit, therefore the discharge gas is contained in the space surrounded by the substrates and sealed frit without a leak.

In order to seal the substrates, frit is applied to surfaces of substrates at around edges of the substrates. The two substrates are assembled with the applied frit in between, and the substrates are heated and pressed to each other. Frit, which is mostly a plastic material, melts and is coated in the surfaces of the substrates. The melted frit, before completely being baked, occasionally spreads into a display area of a PDP, which is an area designed to display visible images. If the frit spreads into the display area, discharge cells formed in the display area are contaminated with the frit, which causes stains in display images and degrades the image quality of the PDP.

### SUMMARY OF THE INVENTION

The present invention provides a plasma display panel (PDP) that prevents a frit or a sealing material from entering into a display region during a sealing process of the PDP.

According to an aspect of the present invention, there is provided a plasma display panel (PDP) including a pair of substrates spaced apart from each other by a predetermined gap and facing each other; a sheet interposed between the pair of substrates and including a barrier rib part and a dielectric part. The barrier rib part has a plurality of holes that defines and forms discharge cells together with the pair of substrates. First discharge electrodes are disposed inside the sheet, and second discharge electrodes are disposed inside the sheet and spaced apart from the first discharge electrodes. A frit or sealing material is interposed between the dielectric part and each of the pair of the substrates. The frit seals a space formed between the pair of the substrates. A groove is formed on the surface of one substrate of the pair of the substrates. The groove is formed around edge of the substrate outside display region, so that the groove effectively prevent frit from spreading into the display region during a sealing process of the PDP. Phosphor layers are disposed in the discharge cells, and a discharge gas is stored in the discharge cells.

The first discharge electrodes and the second discharge electrodes may surround at least a portion of the discharge cells. The first discharge electrodes may extend in a first direction and the second discharge electrodes may cross the first discharge electrodes.

The PDP may further include third discharge electrodes crossing both of the first discharge electrodes and the second discharge electrodes, which extend in a second direction. The third discharge electrodes maybe disposed inside the sheet and spaced apart from the first discharge electrodes and the second discharge electrodes. The third discharge electrodes may surround at least a portion of the discharge cells.

The grooves may be stripe-shaped. The grooves may be spaced apart from one another and discontinuously formed in one of the pair of substrates. The grooves may be formed in a shape of a circle, oval, or polygon. A line connecting centers of grooves at the nearest neighbor columns may have a zigzag shape when proceeding along a horizontal edge of the substrate.

According to another aspect of the present invention, there is provided a plasma display panel (PDP) including a first substrate, a second substrate being spaced apart from the first substrate and facing the first substrate, a barrier rib part formed on the second substrate and interposed between the first substrate and the second substrate, and a dielectric wall formed on a portion of the second substrate on which the barrier rib part is not formed. The dielectric wall is interposed between the first substrate and the second substrate. The barrier rib part defines and forms discharge cells that generate an image.

First discharge electrodes are disposed in the barrier ribs. Second discharge electrodes are disposed in the barrier ribs and spaced apart from the first discharge electrodes. A frit is interposed between the first substrate and the dielectric wall. The frit seals a spaced formed between the first and the second substrates. A groove is formed on the first substrate. The groove is formed in a portion of the first substrate that does not face the barrier rib part. The groove prevents the frit from moving into a display region. Phosphor layers are disposed in the discharge cells, and a discharge gas is stored in the discharge cells.

The first discharge electrodes and the second discharge electrodes may surround at least a portion of the discharge cells. The first discharge electrodes may extend in a first direction and the second discharge electrodes cross the first discharge electrodes. The PDP may further include third discharge electrodes crossing both of the first discharge electrodes and the second discharge electrodes, which extend in a second direction. The third discharge electrodes may be disposed in the barrier ribs and spaced apart from the first discharge electrodes and the second discharge electrodes. The third discharge electrodes may surround at least a portion of the discharge cells. The grooves may be stripe-shaped. The grooves may be spaced apart from one another and discontinuously formed in the first substrates. The grooves may be formed in a shape of a circle, oval, or polygon. A line connecting centers of grooves at the nearest neighbor columns may have a zigzag shape when proceeding along a horizontal edge of the substrate.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a plan view of a plasma display panel (PDP) in which a frit is coated;

FIG. 2 is a partially exploded perspective view of a PDP constructed as an embodiment of the present invention;

FIG. 3 is a cross-sectional view of the PDP of FIG. 2 taken along a line III-III′ in FIG. 2;

FIG. 4 is a cross-sectional view of the PDP of FIG. 2 taken along a line IV-IV′ in FIG. 3;

FIG. 5 is a cross-sectional view of a substrate modified from the substrate of the PDP illustrated in FIG. 2;

FIG. 6 is a partially exploded perspective view of a PDP constructed as another embodiment of the present invention;

FIG. 7 is a cross-sectional view of the PDP of FIG. 6 taken along a line VII-VII′ in FIG. 6; and

FIG. 8 is a cross-sectional view of the PDP of FIG. 6 taken along a line VIII-VIII′ in FIG. 7.

### DETAILED DESCRIPTION OF THE INVENTION

The present invention will now be described in more detail with reference to the accompanying drawings, in which exemplary embodiments of the invention are shown.

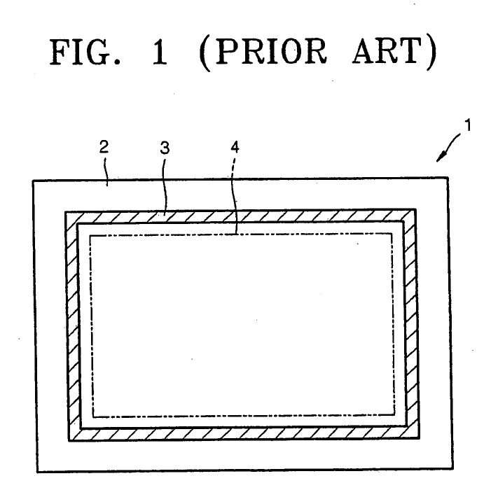

FIG. 1 is a plan view of plasma display panel (PDP) 1. Frit 3 is formed between two substrates 2 (one substrate is below another substrate) at around edges of the substrates. Display region 4 is formed inside frit 3. Visible images are displayed in the display region.

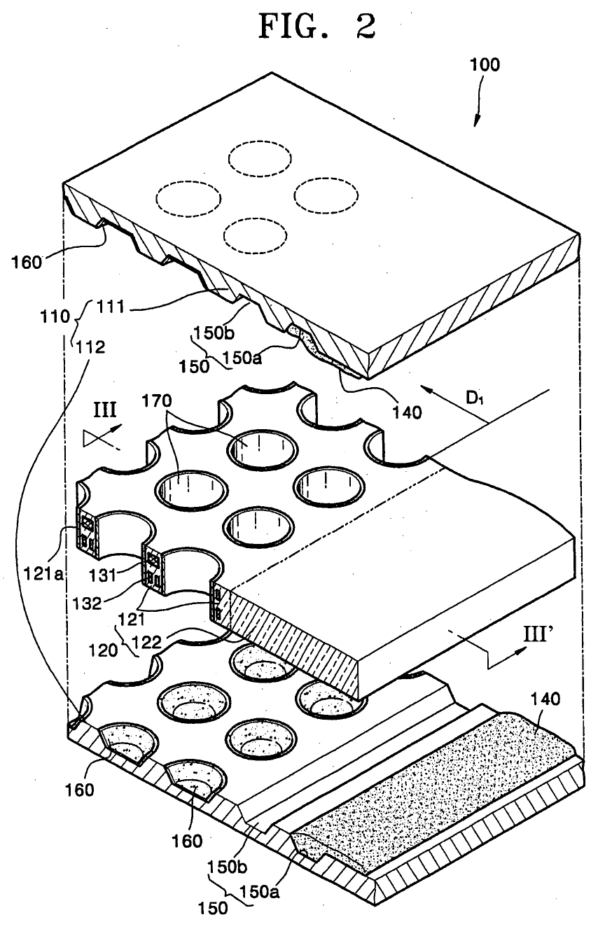

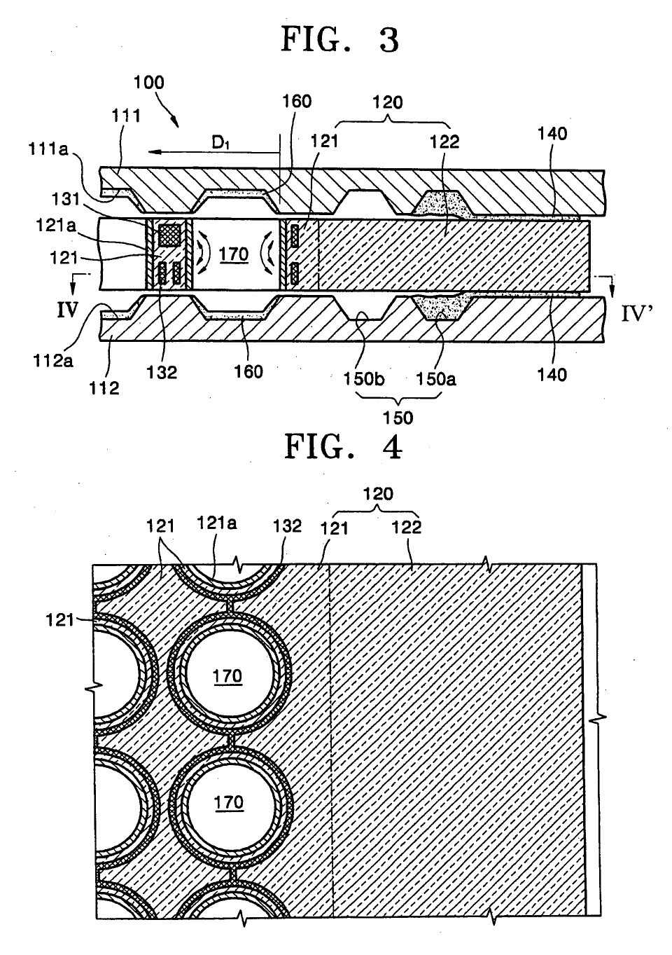

FIG. 2 is a partially exploded perspective view of PDP 100 built as an embodiment of the present invention. FIG. 3 is a cross-sectional view of PDP 100 of FIG. 2 taken along a line III-III′ in FIG. 2. FIG. 4 is a cross-sectional view of PDP 100 of FIG. 2 taken along a line IV-IV′ in FIG. 3.

Referring to FIGS. 2 and 3, PDP 100 includes a pair of substrates 110, sheet 120, first discharge electrodes 131, second discharge electrodes 132, frit 140, groove 150, and phosphor layers 160. The pair of substrates 110 includes first substrate 111 and second substrate 112 which are spaced apart from each other by a predetermined gap and face each other. First substrate 111 is formed of glass through which a visible light is transmitted.

In the current embodiment, first substrate 111 is transparent, and therefore visible light generated during a discharge process is transmitted through first substrate 111. The principle of the present invention, however, is not necessarily restricted to this configuration. In other words, first substrate 111 can be made of an opaque material while second substrate 112 can be made of a transparent material, or both of first and second substrates 111 and 112 can be made of a transparent material. Depending on applications, first and second substrates 111 and 112 can be made of a translucent material and can include a color filter.

Sheet 120 is interposed between the pair of substrates 110 and include barrierrib part 121 and dielectric part 122. Barrier rib part 121 includes holes that forming discharge cells 170 together with the pair of substrates 110. A discharge is generated in the discharge cells 170. Because barrier rib part 121 together with the pair of substrates 110 encloses discharge cells, display region D1 is formed in barrier rib part 121. Barrier rib part 121 of the current embodiment of the present invention includes discharge cells 170 whose inside are coated with phosphor layers 160, and includes display region D1 where the image is displayed, but the construction is not necessarily restricted to this configuration. Barrier rib part 121 can include dummy discharge cells where the image is not displayed. The dummy discharge cells may not be accompanied with a discharge electrode or a phosphor layer, and a discharge is not generated in the dummy discharge cells. In this case, the dummy discharge cells can be formed along the inside of the border of dielectric part 122, or can be placed between discharge cells 170.

Dielectric part 122 is connected to barrier rib part 121, and is arranged in edges of sheet 120. Dielectric part 122 seals the space formed between a pair of substrates 110.

In the current embodiment of the present invention, discharge cells 170 have circular cross-sections as shown in FIG. 2, but the shape is not necessarily restricted to the circular shape, and may have other cross-sections such as a triangle, a tetragon, an octagon, etc. or an oval cross sections.

Barrier rib part 121 is made of a dielectric substance. First discharge electrodes 131 and second discharge electrodes 132 are buried in barrier rib part 121. The dielectric substance forming barrier rib part 121 prevents electrical short between first discharge electrodes 131 and second discharge electrodes 132, and prevents damages of first discharge electrodes 131 and second discharge electrodes 132 due to collisions of charge particles with the first discharge electrodes 131 and the second discharge electrodes 132. The dielectric substance enables accumulation of wall charges induced by charge particles. The dielectric substance may be lead oxide (PbO), boric oxide (B₂O₃), or silicon oxide (SiO₂).

Dielectric part 122 and barrier rib part 121 can be made of the same dielectric substance, but are not necessarily restricted thereto. Dielectric part 122 and barrier rib part 121 can be made of different dielectric materials. In this case, because a discharge is not generated in dielectric part 122, a dielectric material for dielectric part 122 can be selected to have a proper magnitude of dielectric constant.

Protection layers 121a, which is made of magnesium oxide (MgO), cover side walls of discharge cells 170 formed in barrier rib part 121. Protection layers 121a prevent damages of barrier rib part 121, first discharge electrodes 131, and second discharge electrodes 132, which can be caused by sputtering of plasma particles. Protection layers 121a enables generating secondary discharge electrons, which as a result reduces discharge voltage.

Second discharge electrodes 132 are spaced apart from first discharge electrodes 131, and extend in a direction that crosses the extension direction of first discharge electrodes 131. First discharge electrodes 131 of the current embodiment extend in a first direction, and second discharge electrodes 132 cross first discharge electrodes 131. An address discharge can be driven between first discharge electrodes 131 and second discharge electrodes 132 as well as a sustain discharge. The arrangement of the electrodes, however, is not necessarily restricted to this arrangement. The PDP of the present invention may include third electrodes that drive an address discharge.

First discharge electrodes 131 and second discharge electrodes 132 surround each of discharge cells 170. Referring to FIG. 4, second discharge electrodes 132 have a circular ring cross-section. Although not shown in FIG. 4, first discharge electrodes 131 also have a circular ring cross-section. Even though first discharge electrodes 131 and second discharge electrodes 132 of the current embodiment of the present invention are illustrated to have the circular ring cross-sections, first discharge electrodes 131 and second discharge electrodes 132 surrounding the discharge cells 170 can have various cross-sections such as a trapezoidal, an oval, or a polygonal ring cross-sections.

A sustain discharge is generated between first discharge electrodes 131 and second discharge electrodes 132. In this embodiment, first discharge electrodes 131 and second discharge electrodes 132 are illustrated to surround discharge cells 170 as shown in FIG. 4, so that a sustain discharge is generated along side walls of discharge cells 170 (refer to arrows depicted in discharge cells 170 of FIG. 3). The location of the sustain discharge, however, depends on an arrangement of first discharge electrodes 131 and second discharge electrodes 132, and is not necessarily restricted to the locations illustrated in FIGS. 3 and 4. In other words, first discharge electrodes 131 and second discharge electrodes 132 can be stripe-shaped, and can be alternately buried in barrier rib part 121, with first discharge electrodes 131 and second discharge electrodes 132 disposed at one side of a discharge cell and at another side of the discharge cell, respectively. In this case, a sustain discharge is generated across the discharge cell between side walls facing each other. It is also possible to make first discharge electrodes 131 and second discharge electrodes 132 have a disconnected ring structure. In this case, first discharge electrodes 131 and second discharge electrodes partially surround each of discharge cells 170.

Since first discharge electrodes 131 and second discharge electrodes 132 are buried in sheet 120, first discharge electrodes 131 and second discharge electrodes 132 do not need to be made of a transparent conductive material, and can be made of a high conductive metal such as silver (Ag), aluminum (Al), copper (Cu), etc. Therefore, the high conductive electrodes improves discharge response speed, and prevents distortion of voltage signals applied through the electrodes. As a result, power consumption required for the sustain discharge is reduced.

Frit 140 is disposed between dielectric part 122 of sheet 120 and each of first and second substrates 111 and 112 to seal a space formed between first and second substrates 111 and 112. Groove 150, having a stripe shape, is formed in first and second substrates 111 and 112. Groove 150 is formed in a portion where first and second substrates 111 and 112 face dielectric part 122. Groove 150 prevents frit 140 from entering into barrier rib part 121 during a sealing process. When frit 140 is pressed during a sealing process, frit 140 spreads into a space between dielectric part 122 and substrate 111 or 112. Groove 150 prevents frit 140 from further moving towards barrier rib part 121. Groove 150 is spaced apart from barrier rib part 121 by a predetermined gap in order to prevent frit 140 from entering into barrier rib part 121. In this case, the predetermined gap is properly determined based on a width of dielectric part 122 and an amount of frit 140.

Groove 150 includes first groove 150a and second groove 150b. If the welded frit 140 fills first groove 150a and further moves towards barrier rib part 121 during a sealing process, second groove 150b prevents frit 140 from moving towards barrier rib part 121. In this embodiment, groove 150 includes two sub-grooves 150a and 150b that are formed in an edge of first and second substrates 111 and 112, but the number of sub-grooves is not necessarily restricted to two. The number of sub-grooves included in groove 150 can be one, three, four, or any number depending on design and applications.

Groove 150 is stripe-shaped and continuously extended along an edge of one of the pair of substrates 110, but the shape and arrangement of groove 150 are not necessarily restricted thereto. Groove 150 can be discontinuously arranged in a portion of one of the pair of substrates 110, and each of discontinuously arranged grooves (or sub-grooves) are spaced apart from each other. A shape of groove 150 can be circular, oval, polygonal, etc. A depth of groove 150 can be large enough to be filled with frit 140 to prevent frit 140 from entering to the barrier rib part 121.

Phosphor layers 160, which include red, green, and blue type phosphor layers, are formed in recess parts 111a and 112a that are formed on first substrate 111 and second substrate 112, respectively, as shown in FIG. 3. Recess parts 111a and 112a are formed by sand blasting method, etching method, etc. Recess parts are formed on a portion of the substrates corresponding to discharge cells 170.

Phosphor layers 160 have a component generating a visible light when stimulated by ultraviolet rays. A red type phosphor layer that emits red light has a phosphor such as Y(V,P)O₄:Eu, a green type phosphor layer that emits green light has a phosphor such as Zn₂SiO₄:Mn, YBO₃:Tb, and a blue type phosphor layer that emits blue light has a phosphor such as BAM:Eu.

Phosphor layers 160 of the current embodiment of the present invention are formed by coating recess parts 111a and 112a formed on first substrate 111 and second substrate 112, respectively, with phosphor materials mentioned above, but phosphor layers 160 could be coated in other portions of each of discharge cells 170. Phosphor layers 160 can be formed in any portion of discharge cells 170 such as a side wall of discharge cells 170 formed on barrier rib part 121.

After the pair of substrates 110 is sealed, a discharge gas such as neon (Ne), xenon (Xe), or a mixture thereof is filled in PDP 100.

Manufacturing process and functions of PDP 100 of the current embodiment of the present invention will now be described in detail. Processes of manufacturing PDP 100 can be classified into processes of forming sheet 120, forming groove 150 in a pair of substrates 110, forming phosphor layers 160 on the substrates, assembling and sealing the substrates, and injecting a discharge gas into a space formed between the assembled substrates.

In the manufacturing process of sheet 120, first discharge electrodes 131 are buried in a sheet by sequentially depositing dielectric substances on the sheet, and then second discharge electrodes 132 are buried in the sheet, and dielectric substances are sequentially deposied on the sheet. After the sheet is completed, holes are made on a portion of the sheet, which is now barrier rib part 121, to form discharge cells 170. The rest of the portion of the sheet that does not have holes becomes dielectric part 122. In this embodiment, dielectric part 122 is formed around an edge portion of the sheet.

Protective layers 121 a made of magnesium oxide (MgO) are formed on the side walls of discharge cells 170 by vacuum deposition method. Recess parts 111a and 121a are formed on first substrate 111 and second substrate 112, respectively, by a glass-cutting method such as sand blast method, etching method, etc. Recess parts 111a and 121a are formed in a manner that the locations of recess parts 111a and 121a are matched with the locations of holes formed in sheet 120. Phosphor layers 160 are formed by coating phosphor substance on recess parts 111a and 112a. Groove 150 is formed on an edge portion of the pair of substrates 110, in which discharge cells 170 are not formed, by a glass-cutting method such as sand blast method, etching method, etc.

In an assembly and a sealing processes, sheet 120 is inserted between the pair of substrates 110. In this assembling operation, frit 140 is coated between dielectric part 122 of sheet 120 and each of the pair of substrates 110. Frit 140 together with dielectric part 122 of sheet 120 seals the space formed between first and second substrates 111 and 112. Edges of the pair of substrates 110 are heated and pressed. Frit 140 begins to melt under the heat, and spreads into the space between each of the pair of substrates 110 and dielectric part 122. As frit 140 flows into the space between each of the pair of substrates 110 and dielectric part 122, frit 140 fills groove 150, which prevents frit 140 from further spreading into the region of barrier rib part 121.

After the sealing process, a basic structure of PDP 100 is completed. In an injection process, vacuum is applied inside PDP 100, and then a discharge gas is injected into PDP 100.

After the manufacturing of PDP 100 and the injection of the discharge gas are completed, an address voltage is applied between first discharge electrodes 131 and second discharge electrodes 132 from an external power source to generate an address discharge. During the address discharge, discharge cells, in which a sustain discharge will be generated, is selected among discharge cells 170.

If a sustain voltage is applied between first discharge electrodes 131 and second discharge electrodes 132 of the selected discharge cell 170, the wall charges, which are accumulated on the side walls of discharge cells 170 during the address discharge move, thereby generating a sustain discharge. As an energy level of the discharge gas excited during the sustain discharge drops, the discharge gas emits ultraviolet rays. The ultraviolet rays excite phosphor layers 160. When an energy level of the excited phosphor layers 160 drops, a visible light is emitted. The emitted visible light is transmitted through first substrate 111 and forms an image to be recognized by a user.

In the current embodiment of the present invention, frit 140 is prevented from entering into display region D1, which is formed inside barrier rib part 121, due to groove 150 formed in the pair of substrates 110. Therefore, there is no stain caused by frit 140 in the display region D1, and image quality of the display is improved. In other words, PDP 100 formed with groove 150 in the pair of substrates 110 prevents frit 140 from entering into barrier rib part 121 that includes a display region D1, and therefore prevents stains in images displayed on the display region D1, and improves the image quality and reduces the manufacturing cost.

First discharge electrodes 131 and second discharge electrodes 132 of PDP 100 surround discharge cells 170 as shown in FIG. 4, so that a sustain discharge is generated along perimeter of discharge cells 170. Therefore, PDP 100 has a relatively wide discharge area, thereby increases light emitting brightness and discharge efficiency.

Since PDP 100 includes sheet 120, it is not necessary to deposit another barrier rib on the pair of substrates 110 in order to form discharge cells 170. That is, discharge cells 170 are formed by forming holes in sheet 120 where a discharge is generated, thereby manufacturing process is simplified and manufacturing cost is reduced.

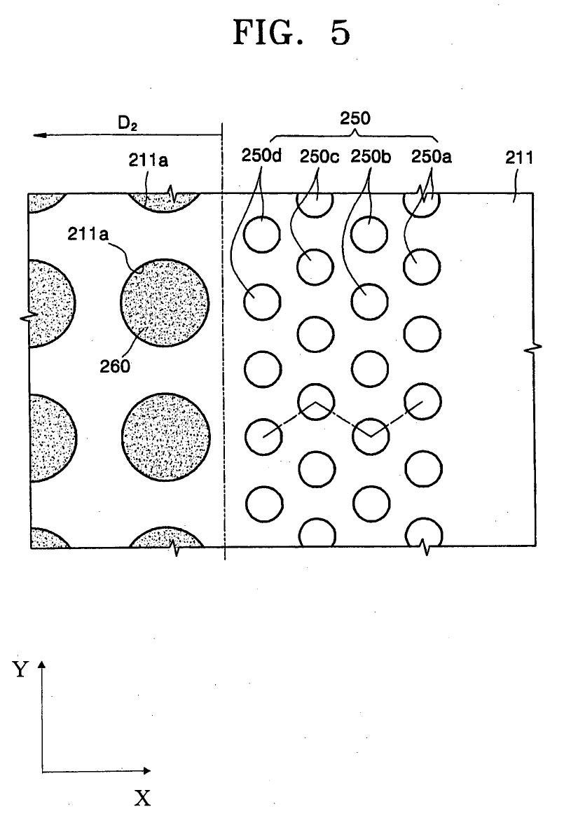

FIG. 5 is a plan view of first substrate 211 that is modified from first substrate 111 of PDP 100 illustrated in FIG. 2. The difference between first substrate 211 and first substrate 111 of PDP 100 will now be described. Referring to FIG. 5, groove 250 and recess parts 211a coated with phosphor layers 260 are formed in first substrate 211. Groove 250 includes a plurality of sub-grooves and is discontinuously arranged (sub-grooves of groove 250 are spaced apart and disconnected from one another). Groove 150 shown in FIGS. 2-4 are stripe-shaped and continuously stretched, but sub-grooves of groove 250 shown in FIG. 5 are circular-shaped, spaced apart from one another, and discontinuously arranged.

If groove 250 is discontinuously arranged as shown in FIG. 5, it has an advantage that the same manufacturing process for recess parts 211a could be used for the manufacture of groove 250. However, in this configuration of groove 250, a frit can easily enter into display region D2 through an area where sub-grooves are not formed. Therefore, in the current embodiment of the present invention, the relative locations of sub-grooves are adjusted to prevent the leak of the frit. FIG. 5 shows a series of columns of grooves 250a-250d. Grooves at each column are shifted upwards or downward with respect to the grooves at neighbor columns. Therefore, as shown in FIG. 5, when proceeding along a horizontal edge of substrate 211 (X-axis), a line connecting centers of grooves at the nearest neighbor columns has a zigzag shape. In this case, it is noted that when proceeding along a vertical edge of substrate 211 (Y-axis), a line connecting centers of grooves at the nearest neighbor rows also has a zigzag shape. Herein, this type of arrangement of grooves is defined as a zigzag pattern of groove. A shape of each groove in the pattern can be different, and groove 250 can have mixed shapes of sub-grooves. For example, one group of grooves can have a circular shape and another group of grooves can have a triangular shape. Even though shapes of grooves are different, zigzag pattern of groove can be maintained as long as the line connecting centers of grooves at the nearest neighbor columns has a zigzag shape when proceeding along X-axis. The zigzag pattern of groove 250 effectively prevents the frit from entering into display region D2.

The principles of limiting movement of the frit due to groove 250 will now be described. The frit moves toward the center of first substrate 211 during a sealing process, and fills first column of grooves 250a formed in edges of first substrate 211. Thereafter, the frit that is left after being filled in first column of grooves 250a or passes first column of grooves 250a is filed in second column of grooves 250b. Likewise, the frit that is left after being filled in second column of grooves 250b or passes second column of grooves 250b is filed in third column of grooves 250c. The frit that is left after being filled in third column of grooves 250c or passes third column of grooves 250c is filed in fourth column of grooves 250d. Therefore, display region D2 is prevented from being contaminated by the frit.

Groove 250 of the current embodiment of the present invention includes four columns of grooves, i.e. first, second, third, and fourth grooves 250a, 250b, 205c, and 250d, but the number of columns are not necessarily restricted to four. Groove 250 can have any number of columns such as one, two, three, five, or six columns of grooves. Number of columns of grooves is determined according to an amount of the frit and configuration of first substrate 211.

Groove 250 formed in first substrate 211 can be identically formed in a second substrate (not shown). The modified PDP of the current embodiment of the present invention includes discontinuously arranged groove 250 in first substrate 211 and in a second substrate to improve efficiency of process of forming groove 250 and to prevent the frit from entering into display region D2, thereby prevents stain in an image displayed in display region D2 and improves quality of displayed images. The difference between the modified PDP illustrated in FIG. 5 and PDP 100 illustrated in FIG. 1 are described above. Except the differences, the modified PDP illustrated in FIG. 5 has the same functional structure, function, and effect as those of PDP 100 illustrated in FIG. 1, and thus detailed descriptions will be skipped.

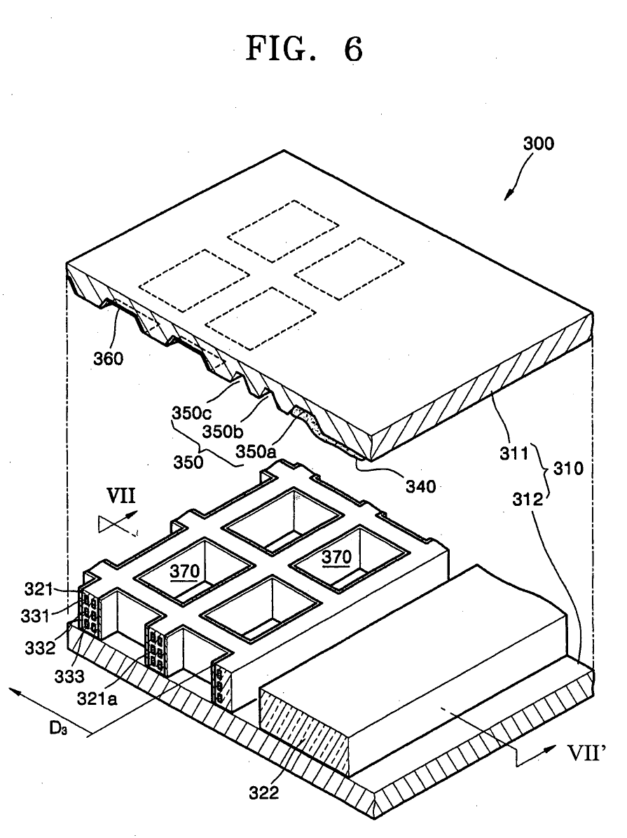

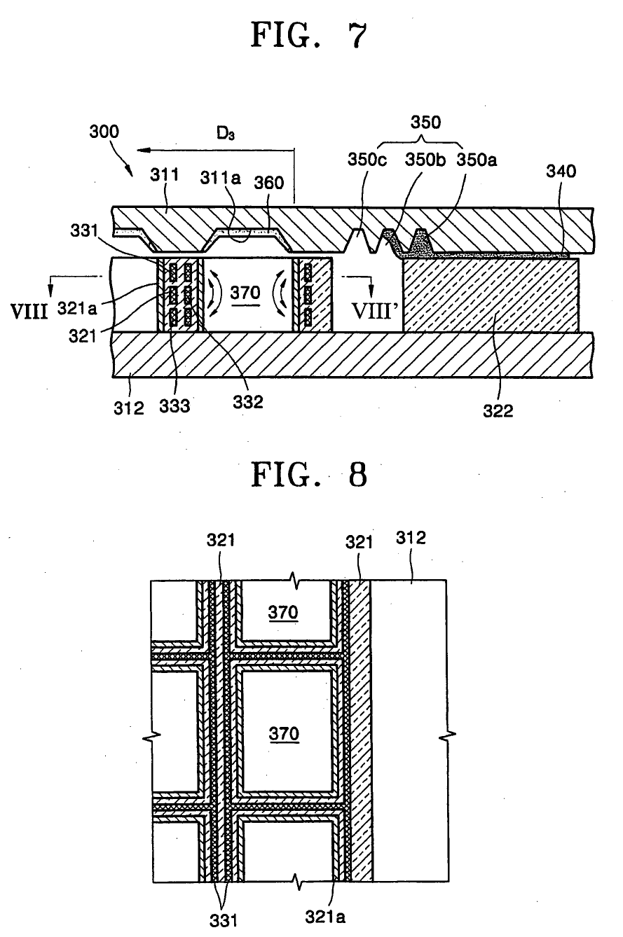

FIG. 6 is a partially exploded perspective view of PDP 300 constructed as another embodiment of the present invention. FIG. 7 is a cross-sectional view of the PDP of FIG. 6 taken along a line VII-VII′ in FIG. 6. FIG. 8 is a cross-sectional view of PDP 300 of FIG. 6 taken along a line VIII-VIII′ in FIG. 7. Referring to FIGS. 6 and 7, PDP 300 includes a pair of substrates 310, barrier rib part 321, dielectric wall 322, first discharge electrodes 331, second discharge electrodes 332, third discharge electrodes 333, frit 340, groove 350, and phosphor layers 360.

The pair of substrates 310 includes first substrate 311 and second substrate 312 which are spaced apart from each other by a predetermined gap and face each other. First substrate 311 is made of glass through which a visible light is transmitted.

Barrier rib part 321 is formed between the pair of substrates 310, and is partitioned to make discharge cells 370 where a discharge is generated. Barrier rib part 321 together with the pair of substrates 310 defines discharge cells 370. Display region D3, in which images are displayed, is formed within barrier rib part 321. Barrier rib part 321 of the current embodiment of the present invention is partitioned to make discharge cells 370, inside of which are coated with phosphor layers 360. Barrier rib part 321 forms display region D3 where the image is displayed. The structure of PDP 300 of the present invention, however, is not necessarily restricted thereto. Barrier rib part 321 may include dummy discharge cells where an image is not displayed.

In the current embodiment of the present invention, discharge cells 370 have tetragonal cross-sections. Dielectric wall 322 is formed in the outside portion of barrier rib part 321, i.e., edge portion of PDP 300. Dielectric wall 322 is formed on second substrate 312, but is not necessarily restricted thereto. In other words, dielectric wall 322 can be formed on first substrate 311. Dielectric wall 322 and frit 340 seal a space formed between the pair of substrates 310.

Barrier rib part 321 is made of dielectric substance. First discharge electrodes 331, second discharge electrodes 332, and third discharge electrodes 333 are buried in barrier rib part 321. The dielectric substance of barrier rib part 321 prevents electrical short between two of first discharge electrodes 331, the second discharge electrodes 332, and the third discharge electrodes 333. The dielectric substance also prevents the electrodes from being damaged caused by collisions of charge particles with first discharge electrodes 331, the second discharge electrodes 332, or the third discharge electrodes 333. The dielectric substance of barrier rib part 321 enables accumulation of wall charges induced by charged particles. The dielectric substance may be lead oxide (PbO), boric oxide (B₂O₃), silicon oxide (SiO₂), etc. Protection layers 321a made of magnesium oxide (MgO) cover side walls of each of discharge cells 370 formed in barrier rib part 321.

Second discharge electrodes 332 are spaced apart from first discharge electrodes 331, and third discharge electrodes 333 are spaced part from second discharge electrodes 332. First discharge electrodes 331 and second discharge electrodes 332 extend in a first direction, and third discharge electrodes 333 cross first discharge electrodes 331 and second discharge electrodes 332 to perform an address discharge. The arrangement of first, second, and third discharge electrodes 331, 332, and 333 of the current embodiment of the present invention is not necessarily restricted thereto. Two electrodes among first, second, and third discharge electrodes 331, 332, and 333 can be extended in the same direction, and the other left electrode can be extended crossing the two electrodes. In this case, one of the two electrodes is a scan electrode, and another electrode is a common electrode. The other left electrode that crosses the two electrode becomes an address electrode.

First, second, and third discharge electrodes 331, 332, and 333 surround each of discharge cells 370. Referring to FIG. 8, first discharge electrodes 331 are trapezoidal-shaped. Although not shown in the figure, second and third discharge electrodes 332 and 333 are also trapezoidal-shaped. Even though first, second, and third discharge electrodes 331, 332, and 333 surround each of the discharge cells 370 in this embodiment, the structures of the electrodes are not necessarily restricted thereto. First, second, and third discharge electrodes 331, 332, and 333 can be stripe-shaped. In this case, first, second, and third discharge electrodes 331, 332, and 333 have a discharge path across a discharge cell, for example, between side walls of a discharge cell that faces each other. Also, first, second, and third discharge electrodes 331, 332, and 333 can partially surround each of discharge cells 370.

Since first, second, and third discharge electrodes 331, 332, and 333 are formed inside barrier rib part 321, they can be made of a non-transparent but highly conductive metal such as silver (Ag), aluminum (Al), or copper (Cu), etc.,

Frit 340 is coated between dielectric wall 322 and first substrate 311 to seal the space formed between first and second substrates 311 and 312. Groove 350 are formed in first substrate 311 in a stripe shape. Groove 350 can be formed in a portion of first substrate 311 that does not face barrier rib part 321. In the other words, groove 350 is formed in a portion of first substrate 311 that does not overlap with barrier rib part 321. Groove 350 prevent frit 340 from entering into barrier rib part 321 during a sealing process. When frit 340 is pressed during the sealing process, frit 340 spreads into a space between first substrate 311 and dielectric rib 322, and groove 350 prevents frit 340 from further moving into barrier rib part 321. Groove 350 is spaced apart from barrier rib part 321 by a predetermined gap in order to prevent frit 340 from entering into barrier rib part 321. In this case, the predetermined gap is properly determined based on a width of dielectric wall 322 and an amount of frit 340.

Groove 350 includes first groove 350a, second groove 350b, and third groove 350c. If the welded frit 340 fills first groove 350a and further moves towards barrier rib part 321 during the sealing process, second and third grooves 350b and 350c prevent frit 340 from moving into barrier rib part 321. In this embodiment, three columns of grooves are included in groove 350, and formed in an edge of first and second substrates 311 and 312, but the number is not necessarily restricted thereto. The number of grooves included in groove 350 can be one, two, four, five, or any number depending on design.

Groove 350 is stripe-shaped and continuously extended along an edge of first substrate 311, but not necessarily restricted to this configuration. Groove 350 can be discontinuously formed in a portion of first substrate 311. In this case, a shape of each of groove 350 or sub-grooves included in groove 350 can be circular, oval, polygonal, etc. The thickness of groove 350 can be large enough to fill frit 340 in order to prevent frit 340 from entering to barrier rib part 321.

Recess parts 311 a are formed on first substrate 311, and coated with phosphor layers 360 according to discharge cells that emit red, green, or blue light. Recess parts 311 a are formed by sand blasting method, etching method, etc. on a portion of first substrate 311 on which discharge cells 370 are formed. Phosphor materials of phosphor layers 360 are the same as those of phosphor layers 160 illustrated in FIG. 1, and detailed description will be skipped. After the pair of first and second substrates 310 is sealed, a discharge gas such as neon (Ne), xenon (Xe), or a mixture thereof is filled in PDP 300.

Manufacturing processes of PDP 300 according to the current embodiment of the present invention will now be described in detail. Processes of manufacturing PDP 300 can be classified into processes of forming barrier rib part 321 and dielectric wall 322 in second substrate 312, forming recess parts 311a, forming phosphor layers 360, forming groove 350 in first substrates 311, assembling, sealing, and injecting a discharge gas.

The operation of forming barrier rib part 321 and dielectric wall 322 in second substrate 312 will now be described. Barrier rib part 321 is formed by depositing a dielectric substance on second substrate 312 in which third discharge electrodes 333, second discharge electrodes 332, and first discharge electrodes 331 are sequentially buried using sand blast method, screen printing method, etc.

Dielectric wall 322 is formed by depositing a dielectric substance on second substrate 312 using sand blast method, screen printing method, etc. Protective layers 321 a made of magnesium oxide (MgO) are disposed on the side walls of barrier rib part 321 using vacuum deposition.

Recess parts 31 la are formed on first substrate 311 where discharge cells 370 are arranged using sand blast method, etching method, etc. Phosphor layers 360 are formed by coating phosphor substances on recess parts 311a.

Groove 350 is formed in a shape of stripe on a portion of first substrate 311, where frit 340 is applied. Groove 350 can be made by sand blast method, etching method, etc. The location of groove 350 can be properly determined based on a width of dielectric wall 322 and an amount of frit 340.

In an assembly and a sealing process, frit 340 is coated between first substrate 311 and dielectric wall 322, and first and second substrates 311 and 312 are assembled. In this case, edge portion of the pair of substrates 310 are heated and pressed. Frit 340 begins to melt and spreads into a space between first substrate 310 and dielectric wall 322. Groove 350 is filled with frit 340, and prevent frit 340 from further moving into barrier rib part 321, so that frit 340 is not able to reach barrier rib part 321. After the sealing is completed, vacuum is applied to PDP 300, and a discharge gas is injected into PDP 300.

The operation of PDP 300 will now be described. After the injection of the discharge gas is completed, a predetermined address voltage is applied from an external power source between third discharge electrodes 333 and one of first discharge electrodes 331 and second discharge electrodes 332 that is determined as scan electrodes to generate an address discharge. Discharge cells, in which a sustain discharge is generated, is selected from discharge cells 370 during the address discharge.

If a discharge sustain voltage is applied between first discharge electrodes 331 and second discharge electrodes 332 of the selected discharge cells, wall charges accumulated on the side walls of discharge cells move, thereby a sustain discharge is generated. As an energy level of the discharge gas excited during the sustain discharge drops, the discharge gas emits ultraviolet rays. The ultraviolet rays excite phosphor layers 360. When an energy level of the excited phosphor layers 360 drops, a visible light is emitted. The emitted visible light is transmitted through first substrate 311 and forms images to be recognized by a user.

In the current embodiment of the present invention, frit 340 is prevented from entering into display region D3 by groove 350, and there is no stain in an image displayed in display region D3 and image quality is improved. PDP 300 formed with groove 350 in first substrate 311 prevents frit 340 from entering into barrier rib part 321, thereby prevents stains in the image displayed on display region D3, improves the image quality, and reduces the manufacturing cost.

First, second, and third discharge electrodes 331, 332, and 333 of PDP 300 surround discharge cells 370 so that the sustain discharge is generated along perimeter position of each of discharge cells 370. Therefore, PDP 300 has a relatively wide discharge area, thereby increases light emitting brightness and discharge efficiency.

The PDP of the present invention formed with a groove in one of a pair of substrates prevents a frit from entering into a display region, thereby prevents stain in an image displayed in the display region. Therefore, quality of the PDP is improved, and cost for manufacturing the PDP is reduced.

Also, since the discharge electrodes of the PDP of the present invention are buried in a sheet or barrier rib part, and surround discharge cells, the PDP has a relatively wide discharge area, thereby increases light emitting brightness and light emitting efficiency.

The PDP of the present invention is manufactured by forming holes in a sheet to make a discharge space in the sheet, and by disposing the sheet having the discharge space between the pair of substrates, thereby the structure of the PDP simplifies a manufacturing process and reduces manufacturing cost.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel (PDP) comprising:
a pair of substrates spaced apart from each other and facing each other;
a sheet interposed between the pair of the substrates, and including a barrier rib part and a dielectric part, the barrier rib part having a plurality of holes for forming discharge cells that generate an image, the dielectric part being arranged around an edge portion of the sheet;
a plurality of first discharge electrodes disposed inside the sheet;
a plurality of second discharge electrodes disposed inside the sheet and spaced apart from the first discharge electrodes;
a frit interposed between each of the pair of the substrates and the dielectric part, the frit sealing a space formed between the pair of the substrates;
a groove formed in a substrate of the pair of the substrates, the groove formed in a portion of the substrate that faces the dielectric part;
a phosphor layer disposed in each of the discharge cells; and
a discharge gas stored in the discharge cells.

2. The PDP of claim 1, wherein each of the first discharge electrodes and each of the second discharge electrodes surround at least a portion of the holes.

3. The PDP of claim 1, comprised of the first discharge electrodes extending in a first direction, and comprised of the second discharge electrodes crossing the first discharge electrodes.

4. The PDP of claim 1, further comprising a plurality of third discharge electrodes crossing both of the first discharge electrodes and the second discharge electrodes, both of the first discharge electrodes and the second discharge electrodes extending in a second direction.

5. The PDP of claim 4, wherein the third discharge electrodes are disposed inside the sheet, and spaced apart from the first discharge electrodes and the second discharge electrodes.

6. The PDP of claim 5, wherein the third discharge electrodes surround a portion of at least one hole of the plurality of the holes.

7. The PDP of claim 1, comprised of the groove being stripe-shaped.

8. The PDP of claim 1, wherein the groove includes a plurality of sub-grooves, each of the sub-grooves being disconnected from one another and spaced apart from one another.

9. The PDP of claim 8, wherein each of the sub-grooves is formed in a shape selected from the group consisting of a circle, an oval, and a polygon.

10. The PDP of claim 8, comprised of the sub-grooves formed into a zigzag pattern along a direction parallel to one edge of a substrate of the pair of the substrates.

11. A plasma display panel (PDP) comprising:
a first substrate;
a second substrate being spaced apart from the first substrate and facing the first substrate;
a barrier rib part interposed between the first substrate and the second substrate, the barrier rib part defining a plurality of discharge cells together with the first substrate and the second substrate;
a dielectric wall formed on a portion of the second substrate, the dielectric wall interposed between the first substrate and the second substrate;
a plurality of first discharge electrodes disposed inside the barrier rib part;
a plurality of second discharge electrodes disposed inside the barrierrib part and spaced apart from the first discharge electrodes;
a frit interposed between the first substrate and the dielectric wall, the frit sealing a space formed between the first substrate and the second substrate;
a groove formed on the first substrate, the groove formed in a portion of the first substrate that does not face the barrier rib part;
a phosphor layer disposed in each of the discharge cells; and
a discharge gas stored in the discharge cells.

12. The PDP of claim 11, wherein each of the first discharge electrodes and each of the second discharge electrodes surround at least a portion of the discharge cells.

13. The PDP of claim 11, comprised of the first discharge electrodes extending in a first direction, and comprised of the second discharge electrodes crossing the first discharge electrodes.

14. The PDP of claim 11, further comprising a plurality of third discharge electrodes crossing both of the first discharge electrodes and the second discharge electrodes, both of the first discharge electrodes and the second discharge electrodes extending in a second direction.

15. The PDP of claim 14, wherein the third discharge electrodes are disposed inside the barrier rib part, and spaced apart from the first discharge electrodes and the second discharge electrodes.

16. The PDP of claim 15, wherein the third discharge electrodes surround a portion of at least one of the discharge cells.

17. The PDP of claim 11, comprised of the groove being stripe-shaped.

18. The PDP of claim 11, wherein the groove includes a plurality of sub-grooves, each of the sub-grooves being disconnected from one another and spaced apart from one another.

19. The PDP of claim 18, wherein each of the sub-grooves is formed in a shape selected from the group consisting of a circle, an oval, and a polygon.

20. The PDP of claim 18, comprised of the sub-grooves formed into a zigzag pattern along a direction parallel to one edge of a substrate of the pair of the substrates.
